(19) United States
(12) Patent Application Publication
(10) Pub. No.: US 2017/0168596 A1
(43) Pub. Date: Jun. 15, 2017

(54) METHOD OF DISPLAYING INPUT KEYS AND ELECTRONIC DEVICE

(71) Applicant: Lenovo (Beijing) Limited, Beijing (CN)

(72) Inventors: Min Zhang, Beijing (CN); Qiming Chen, Beijing (CN)

(21) Appl. No.: 15/374,804

(22) Filed: Dec. 9, 2016

(30) Foreign Application Priority Data
Dec. 11, 2015 (CN) 201510920865.4
Dec. 11, 2015 (CN) 201510967458.9

(51) Int. Cl. G06F 3/0346; G06F 1/32; G06F 3/0488

(52) U.S. Cl. CPC G06F 3/0346; G06F 3/04886; G06F 1/3206

(57) ABSTRACT

A method is disclosed. In one embodiment, the method may include determining a state of an electronic device. In one embodiment, the method may include determining whether the determined state of the electronic device corresponds to a key input working state. In one embodiment, the method may include, in response to the determined state of the electronic device corresponding to the key input working state, operating an input acquisition unit of the electronic device in a key input working mode and displaying a key section on an input section of the electronic device.

### FIELD

The subject matter disclosed herein relates to the field of electronic technology, and, in particular, to a method of displaying input keys and an electronic device.

### BACKGROUND

Many tablet computers have large screen displays and are portable. However, several tablet computers have limitations, such as the lack of a keyboard. To provide input to a tablet computer, a virtual keyboard may be provided on the tablet computer, often on the display of the tablet computer. However, the power consumption of the virtual keyboard may be quite high.

### SUMMARY

A method is disclosed. In one embodiment, the method may include determining a state of an electronic device. In one embodiment, the method may include determining whether the determined state of the electronic device corresponds to a key input working state. In one embodiment, the method may include, in response to the determined state of the electronic device corresponding to the key input working state, operating an input acquisition unit of the electronic device in a key input working mode and displaying a key section on an input section of the electronic device.

In one embodiment, the method may include determining whether the determined state of the electronic device corresponds to a track input working state and, in response to the determined state of the electronic device corresponding to the track input working state, operating the input acquisition unit of the electronic device in a track input working mode, wherein the track input working mode comprises the input section accepting touch input and controlling the input section to not display the key section.

In one embodiment, the method may include coating the key section of a cover plate of the electronic device with a first material, and coating a section of the cover plate other than the key section with a second material. The first material and the second material belong to a same color scheme and a light transmittance of the first material is greater than that of the second material.

In one embodiment, determining the state of the electronic device may include determining an angle between a first body and a second body of the electronic device. In some embodiments, determining the angle between the first body and the second body may include determining that the angle between the first body and the second body is greater than 0 degrees and less than 360 degrees, and the method further comprises operating the electronic device in a notebook working mode.

In one embodiment, the method may include acquiring a switchover instruction and switching a working mode of the input acquisition unit from the key input working mode to a track input working mode based on the switchover instruction. In one embodiment acquiring the switchover instruction may include acquiring a first parameter from a sensor and generating the switchover instruction based on the first parameter.

An electronic device is disclosed. In one embodiment, the electronic device may include an input section. In one embodiment, the electronic device may include an input acquisition unit. In one embodiment, the electronic device may include a processor coupled to the input acquisition unit. The processor may be configured to determine a state of the electronic device. The processor may be configured to determine whether the determined state corresponds to a key input working state. In one embodiment, the processor may be configured to, in response to the determined state corresponding to a key input working state, operate the input acquisition unit in a key input working mode, the track input working mode including the input section accepting touch input, and display a key section on the input section.

In some embodiments, the processor may be further configured to determine whether the determined state corresponds to a track input working state. The processor may be configured to, in response to the determined state corresponding to a track input working state, operate the input acquisition unit in a track input working mode, and control the input section to not display the key section.

In one embodiment, a first material may coat the key section of a cover plate of the electronic device. A second material may coat a section of the cover plate other than the key section. In some embodiments, the first material and the second material may include a same color scheme and a light transmittance of the first material may be greater than a light transmittance of the second material.

In some embodiments, the state of the electronic device may include an angle between a first body and a second body of the electronic device. In one embodiment, in response to the angle between the first body and the second body being greater than 0 degrees and less than 360 degrees, the state of the electronic device may include a notebook working mode.

In one embodiment, the processor may be further configured to acquire a switchover instruction and switch a working mode of the input acquisition unit from the key input working mode to a track input working mode based on the switchover instruction. In some embodiments, the processor may be further configured to acquire a first parameter from a sensor and generate the switchover instruction based on the first parameter.

A program product is disclosed. The program product may include a non-transitory computer readable storage medium that stores code executable by a processor. The executable code may include code to perform determining a state of an electronic device. The executable code may include code to perform determining whether the determined state of the electronic device corresponds to a key input working state. The executable code may include code to perform, in response to the determined state of the electronic device corresponding to a key input working state, operating an input acquisition unit of the electronic device in a key input working mode and displaying a key section on an input section of the electronic device.

In one embodiment, the executable code may include code to perform determining whether the determined state of the electronic device corresponds to a track input working state. In one embodiment, the executable code may include code to perform, in response to the determined state of the electronic device corresponding to the track input working state, operating the input acquisition unit of the electronic device in a track input working mode, the track input working mode including the input section accepting touch input, and controlling the input section to not display the key section.

In one embodiment, a first material may coat a key section of a cover plate of the electronic device. A second material may coat a section of the cover plate other than the key section. The first material and the second material may include a same color scheme and a light transmittance of the first material is greater than a light transmittance of the second material.

In one embodiment, the code to perform determining the state of the electronic device may include code to perform determining an angle between a first body and a second body of the electronic device. In some embodiments, the code to perform determining the angle between the first body and the second body may include code to perform determining that the angle between the first body and the second body is greater than 0 degrees and less than 360 degrees and operating the electronic device in a notebook working mode.

In one embodiment, the executable code may include code to perform acquiring a switchover instruction and switching a working mode of the input acquisition unit from the key input working mode to a track input working mode based on the switchover instruction.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, embodiments will be described and explained with additional specificity and detail through the use of the accompanying drawings, in which:

FIG. 1 is a schematic flow diagram for a method of displaying keys according to an embodiment of the present application;

FIG. 2 is a schematic diagram of the electronic device in notebook operating mode according to an embodiment of the present application;

FIG. 3 is a schematic diagram of the electronic device in tablet operating mode according to an embodiment of the present application;

FIG. 4 is a schematic flow diagram for a method of determining the working mode of the input acquisition unit according to an embodiment of the present application;

FIG. 5 is a schematic diagram showing writing on a piece of paper using a stylus according to an embodiment of the present application; and

FIG. 6 is a structural block diagram of the electronic device according to an embodiment of the present application.

### DETAILED DESCRIPTION

In the embodiments of the present disclosure, by illuminating the light source contained in the electronic device in response to the input acquisition unit being in a working state and the input acquisition unit operating in a key input working mode, the electronic device may consume less power to operate a virtual keyboard of a tablet computer. The reduced power consumption may increase the battery life of the tablet computer. Several embodiments of the present disclosure will be described in detail below with reference to the accompanying drawings.

In the embodiments of the present disclosure, the electronic device may include a notebook computer, a tablet computer, or the like. The electronic device may include an input acquisition unit with a key input working mode. The input acquisition unit may include an input section. The electronic device may include a cover plate disposed above the input section. The cover plate may include a key section that corresponds to the key input working mode. A key input working mode may include a working mode that accepts input from the key section. A non-key input working mode may include a working mode that does not accept input from the key section. A user may perform an input operation on the key section of the electronic device. For example, the key section may include a keyboard, a virtual keyboard, or the like. In one embodiment, in response to the electronic device being in the key input working mode, the key section may display a virtual keyboard.

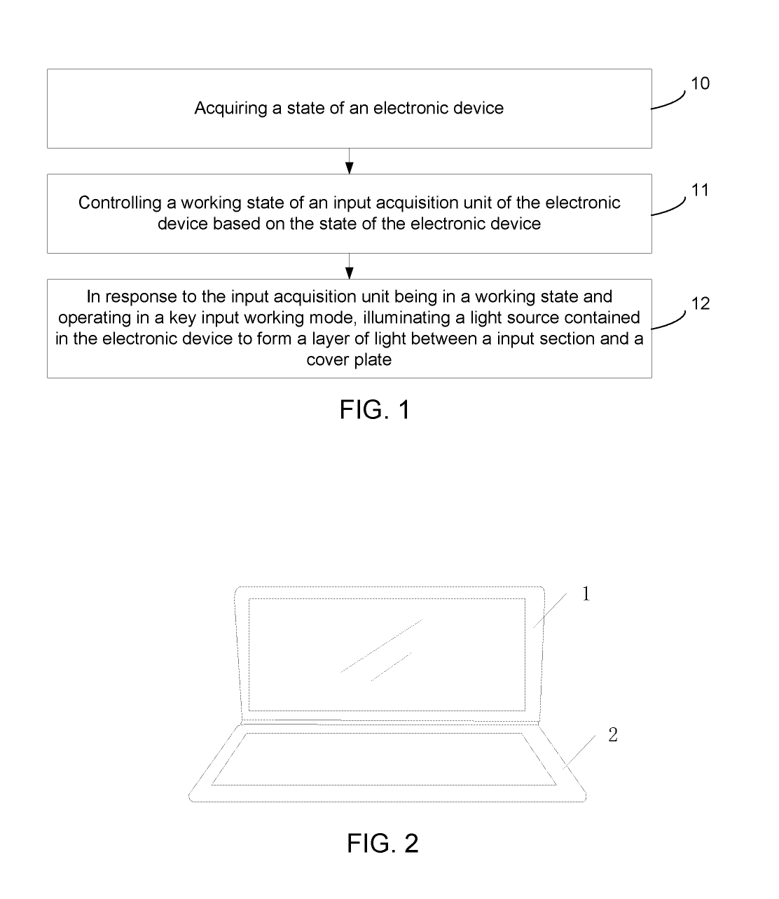

FIG. 1 is a schematic flow diagram illustrating one embodiment of a method. The method may include the following steps.

In one embodiment, the method may include Step 10 acquiring a state of an electronic device. In one embodiment, the method may include Step 11 controlling a working state of an input acquisition unit of the electronic device based on the state of the electronic device. In certain embodiments, the method may include Step 12 in response to the input acquisition unit being in a working state and operating in a key input working mode, the method may include illuminating a light source contained in the electronic device to form a layer of light between the input section and the cover plate.

In one embodiment of Step 10, the state of the electronic device may include an operating state or a low power consumption state. The low power consumption state may include a dormant state, sleep state, hibernation state, a shutdown state, or the like.

In some embodiments of step 11, the electronic device may control the working state of the input acquisition unit of the electronic device based on the state of the electronic device. In one embodiment, in response to the electronic device being in the operating state, the input acquisition unit may be in the operating state. In response to the electronic device being in the low power consumption state, the input acquisition unit may be in the low power consumption state. In some embodiments, the low power consumption state may include the dormant state or the shutdown state.

In some embodiments of Step 12, in response to the input acquisition unit being in the working state and operating in the key input working mode, the electronic device may illuminate a light source contained in the electronic device. The electronic device may form a layer of light between the input section and the cover plate. The layer of light may display the key section on the cover plate. A user may perform an input by interacting with the key section.

The cover plate may include the key section disposed on the cover plate. The key section may correspond to the key input working mode. In one embodiment, a first material may coat the key section. A second material may coat a section of the cover plate other than the key section. The first material and the second material may belong to a same color scheme. In one embodiment, the first and second materials belonging to the same color scheme may include the first and second materials being of the same color or similar colors. The light transmittance of the first material may be greater than that of the second material. In response to the light source illuminating, a layer of light may form between the input section and the cover plate. The light source illuminating may include the light source illuminating the key section, the input section, a portion of the cover plate, or the like. The layer of light may display the key section on the cover plate. In response to the light source not illuminating, since the first material and the second material belong to a same color scheme, when viewed from the angle of a user, the key section and the section other than the key section may form a uniform cover plate. The uniform cover plate may maintain the integrity of the appearance of the electronic device.

In some embodiments, the input acquisition unit may include a track input working mode. The input acquisition unit may be in a working state. In response to the input acquisition unit being in the track input working mode and the working state, the input acquisition unit may operate in the key input working mode or the track input working mode. In response to the input acquisition unit operating in the track input working mode, the electronic device may control the light source to not illuminate. A user may slide his/her finger(s) or a stylus on the cover plate to perform an input on the electronic device.

In one embodiment, the method may include determining the working mode of the input acquisition unit. In some embodiments, an operating mode of the electronic device may include a notebook operating mode or a tablet operating mode. In one embodiment, the electronic device may include an electronic device including a flexible screen. FIG. 2 depicts one embodiment of an electronic device. The electronic device may include a first body 1 and a second body 2. The first body 1 may be rotatable with respect to the second body 2. The first body 1 may include a display screen disposed on the first body 1. The second body 2 may include an input acquisition device and the cover plate. For example, in one embodiment, the first body 1 may be disposed at an initial angle of 0 degrees with respect to the second body 2. The display screen may fit closely to the cover plate. The first body 1 may be rotated and may form an angle of 110 degrees with respect to the second body 2. The operating mode of the electronic device may include the notebook operating mode as shown in FIG. 2.

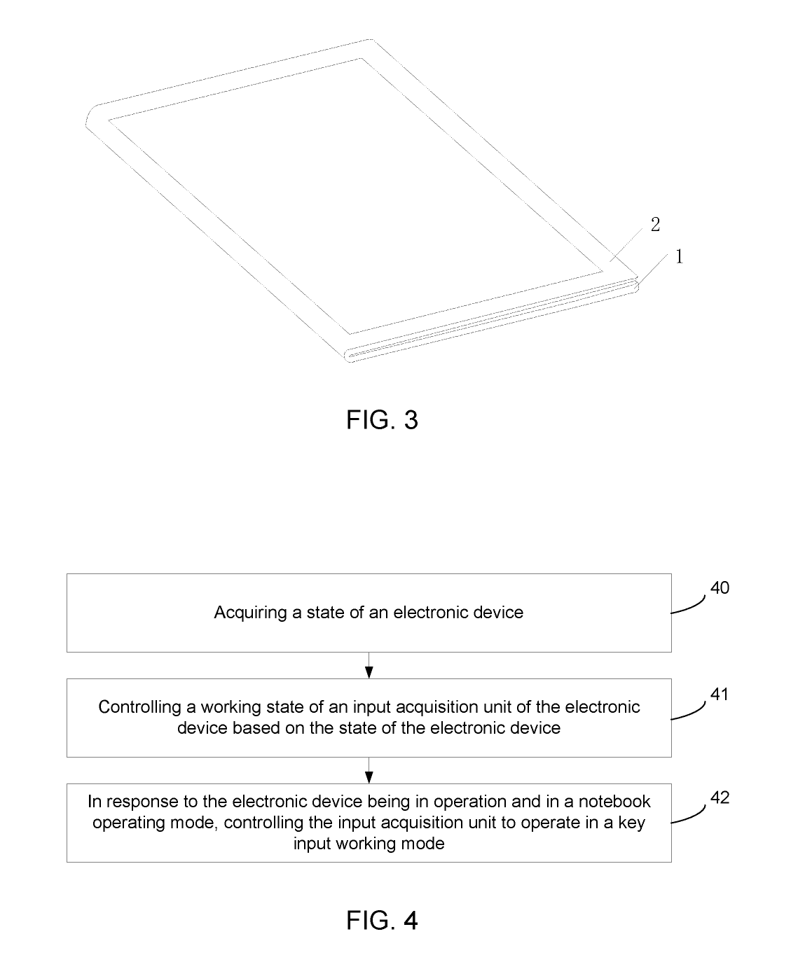

In one embodiment, as shown in FIG. 3, the first body 1 may be rotated and form an angle of 360 degrees with respect to the second body 2. The operating mode of the electronic device may include the tablet operating mode. As depicted in FIG. 3, a backside of the first body 1 may press against a backside of the second body 2. A user may operate the first body 1 and second body 2 like a tablet where the user may grip one or more sides of the first body 1 and/or second body 2. The user may provide input to the display screen and/or the input acquisition device. The display screen and/or the input acquisition device may display content.

FIG. 4 depicts one embodiment of a method for determining the working mode of the input acquisition unit. The method may include the following steps.

In one embodiment, the method may include Step 40 acquiring a state of the electronic device. In some embodiments, the method may include Step 41 controlling the working state of the input acquisition unit based on the state of the electronic device and the operating mode of the electronic device. In one embodiment, the method may include Step 42 in response to the electronic device being in operation and in the notebook operating mode, the method may include controlling the input acquisition unit to operate in the key input working mode. In some embodiments, in response to the electronic device being in operation and in the tablet operating mode, the method may include controlling the input acquisition unit to operate in the track input working mode. In response to the input acquisition unit of the electronic device operating in the track input working mode and the display screen facing a user, the user may watch videos, play games on the electronic device, or the like.

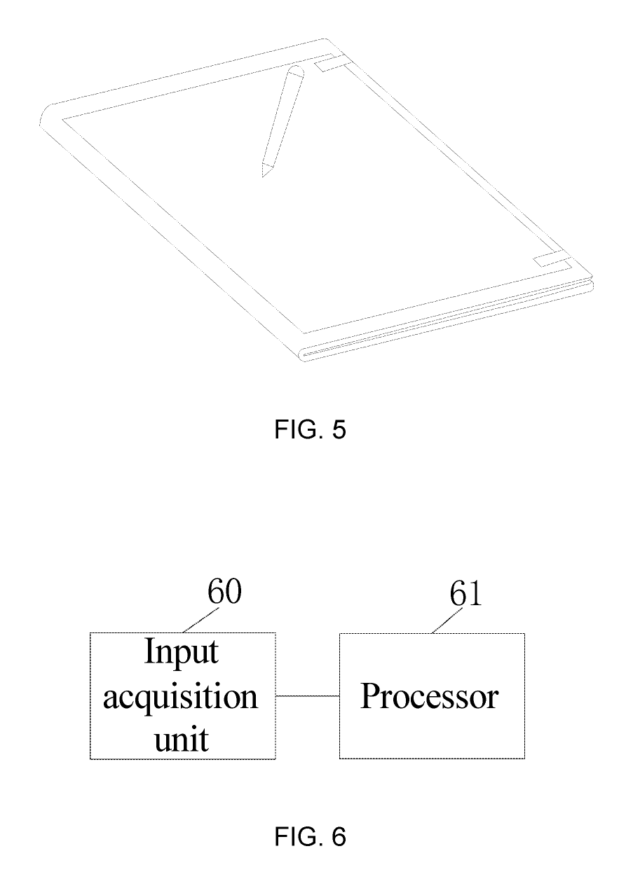

As shown in FIG. 5, in one embodiment, in response to the input acquisition unit facing the user, the user may enter input directly on the input acquisition unit. In one embodiment, the electronic device may operate in the tablet operating mode. The input acquisition unit may be disposed on the second body 2 and the back of the first body 1 may fit against the back of the second body 2. In some embodiments, the user may place a piece of paper 3 on the input acquisition unit and write on it with a stylus 4. The electronic device may synchronize the content written on the paper 3 to the electronic device. In one embodiment, the input acquisition unit may detect touch input from the stylus and record the input location, direction, time, or the like and other information to save the content written by a user.

In some embodiments, the input acquisition unit may switch between two or more working modes. In one embodiment, in response to the input acquisition unit being in operation, the input acquisition may receive a switchover instruction. In response to receiving the switchover instruction, the working mode of the input acquisition unit may switch from the key input working mode to the track input working mode or vice versa.

In one embodiment, the electronic device may obtain a first parameter from a sensor. In response to the electronic device obtaining the first parameter, the method may include generating a switchover instruction based on the first parameter. The switchover instruction may control the electronic device to perform a switchover of the operating mode of the input acquisition unit. In some embodiments, the first parameter may include an angle between the first body 1 and the second body 2. Different angles may represent different operating modes of the electronic device. In one embodiment, the electronic device can generate switchover instructions based on different operating modes.

In one embodiment, in response to a sensor detecting an angle indicating that the electronic device is in the tablet operating mode and that the input acquisition unit is in the key input working mode, the electronic device may generate a switchover instruction. The switchover instruction may include an instruction to switch the working mode of the input acquisition unit from the key input working mode to the track input working mode. In response to a sensor detecting an angle indicating that the electronic device is in the notebook operating mode and that the input acquisition unit is in the track input working mode, the electronic device may generate a switchover instruction. The switchover instruction may include an instruction to switch the working mode of the input acquisition unit from track input working mode to key input working mode.

In some embodiments, the first parameter may include an orientation information of an operating body. In one embodiment, the electronic device may acquire an image of the operating body from an image acquisition unit. The method may include analyzing the acquired image of the operating body to acquire the orientation information of the operating body. In some embodiments, the operating body may include a finger or fingers, a stylus, or the like. The orientation information acquired by the electronic device may include an input by a user using fingers or an input by a user using a stylus. In one embodiment of the present disclosure, in response to the orientation information acquired by the electronic device including an input by a user using several fingers, the input acquisition unit may operate in the key input working mode. In response to the orientation information being an input by a user using a stylus, the input acquisition unit may operate in the track input working mode.

In one embodiment, the electronic device may include a switch for changing the working mode of the input acquisition unit. A user may use the switch to change the working mode of the input acquisition unit.

FIG. 6 depicts one embodiment of an electronic device. The electronic device may include an input acquisition unit 60 and a processor 61 coupled to the input acquisition unit 60. In one embodiment, the processor 61 may acquire the state of the electronic device. The processor 61 may control the working state of the input acquisition unit 60 based on the state of the electronic device. The input acquisition unit 60 may include a key input working mode and an input section. The electronic device may include a cover plate provided above the input section. The cover plate may include a key section that corresponds to the key input working mode.

In one embodiment, in response to the input acquisition unit 60 operating in the key input working mode, the electronic device may illuminate a light source contained in the electronic device to form a layer of light between the input section and the cover plate. The layer of light may display the key section on the cover plate.

In some embodiments, a first material may coat the key section of the cover plate and a second material may coat a section of the cover plate other than the key section. The first material and the second material may belong to a same color scheme. The light transmittance of the first material may be greater than that of the second material.

In certain embodiments, the state of the electronic device may include an operating state or a low power consumption state. The input acquisition unit 60 may include a track input working mode. The processor 61 may acquire an operating mode of the electronic device. The processor 61 may control the working state of the input acquisition unit 60 of the electronic device based on the state of the electronic device. Controlling the working state of the input acquisition unit 60 may include controlling the working state of the input acquisition unit 60 based on the state of the electronic device and the operating mode of the electronic device. In response to the electronic device being in operation and in the notebook operating mode, controlling the working state of the input acquisition unit 60 may include controlling the input acquisition unit 60 to be in operation and operated in the key input working mode.

In some embodiments, the processor 61 may acquire a switchover instruction. The switchover instruction may include switching the working mode of the input acquisition unit 60 from key input working mode to track input working mode. In one embodiment, the processor 61 may acquire a first parameter via detection by a sensor. The processor may generate the switchover instruction based on the first parameter.

As can be seen from the above description, in some embodiments of the present disclosure, by illuminating the light source contained in the electronic device in response to the input acquisition unit 60 being in the working state and the input acquisition unit 60 operating in the key input working mode, the amount of power consumed by the virtual keyboard of a tablet computer may be reduced. The reduced power consumption may prolong the battery life of the tablet computer.

In response to the light source contained in the electronic device illuminating the key section that corresponds to the key input operating mode, the key section may be displayed on the cover plate. A user may perform an input operation on the key section. In response to the light source not illuminating the key section, the section other than the key section may form an intact cover plate. The cover plate may maintain the integrity of the appearance of the electronic device.

In one embodiment of the present disclosure, by determining the operating mode of the electronic device and determining that the electronic device is in the notebook operating mode, the input acquisition unit 60 may operate in the key input working mode. Since a user may perform an input on the electronic device using the virtual keyboard when the operating mode of the electronic device is notebook operating mode, the input acquisition unit 60 may operate in the key input working mode so that the input acquisition unit 60 may operate with reduced power consumption.

Those skilled in the art should understand that the embodiments of the present disclosure may be provided as a method, a system, or a computer program product. Embodiments of the present disclosure may include a hardware-only embodiment, a software-only embodiment, or an embodiment of a combination of hardware and software. The present disclosure may include a computer program product, which may implemented on one or more computer available storage media (including, but not limited to, disk storage, CD-ROM, optical storage, or the like) which may include computer available program codes.

The present disclosure is described with reference to the methods, devices, systems, and flow diagrams and/or block diagrams of computer program products according to the embodiments of the present disclosure. It should be understood that computer program instructions may be used to implement each process and/or block in the flow diagrams and/or block diagrams and combinations of processes and/or blocks in the flow diagrams and/or block diagrams. The computer program instructions may be provided to a universal computer, a dedicated computer, an embedded processor, or the processor of another programmable data processing device to generate a machine. The computer or the processor of another programmable data processing device may execute instructions to generate a unit to implement functions designated in one or more processes in a flow diagram and/or one or more blocks in a block diagram.

The computer program instructions may be stored in a computer readable storage. The computer readable storage may cause a computer or another programmable data processing device to work in a specific manner such that the instructions stored in the computer readable storage may generate a product. The product may include an instruction unit. The instruction unit may implement functions designated by one or more processes in a flow diagram and/or one or more blocks in a block diagram.

In some embodiments, the computer program instructions may be installed in a computer or another programmable data processing device. A series of operation steps are executed on the computer or another programmable device to generate a computer implemented processing. The instructions executed in the computer or another programmable device may provide steps for implementing functions designated in one or more processes in a flow diagram and/or one or more blocks in a block diagram.

In some embodiments, the computer program instructions that correspond to the method of displaying input keys in the embodiments of the present application may be stored in a storage media. The storage media may include a CD-ROM, a hard disk, a USB disk, or the like. In response to the computer program instructions that correspond to the method of displaying input keys being read or executed by an electronic device from the storage media, the following steps may be performed. The steps may include acquiring a state of an electronic device, controlling a working state of an input acquisition unit of the electronic device based on the state of the electronic device, the input acquisition unit including a key input working mode, and the input acquisition unit including an input section. The electronic device may include a cover plate provided above the input section and the cover plate may include a key section that corresponds to the key input working mode. In response to the input acquisition unit being in the working state and operating in the key input working mode, the steps may include illuminating a light source contained in the electronic device to form a layer of light between the input section and the cover plate, thereby displaying the key section on the cover plate. The steps may include steps of the methods described above.

While some embodiments of the present disclosure have been described, variations and modifications may be made to these embodiments once the basic creative concept is obtained by those skilled in the art. Thus, the attached claims are intended to be explained as including some embodiments and variations and modifications that fall within the scope of the present disclosure. Clearly, various variations and modifications to the present disclosure may be made by those skilled in the art without departing from the spirit and scope of the present disclosure. Accordingly, if these variations and modifications to the present disclosure fall within the scope of the claims of the present disclosure and the equivalents thereof, it is also intended that the present disclosure encompass these variations and modifications.

What is claimed is:

1. A method comprising:
determining a state of an electronic device;
determining whether the determined state of the electronic device corresponds to a key input working state; and
in response to the determined state of the electronic device corresponding to the key input working state
operating an input acquisition unit of the electronic device in a key input working mode, and
displaying a key section on an input section of the electronic device.

2. The method of claim 1, further comprising:
determining whether the determined state of the electronic device corresponds to a track input working state; and
in response to the determined state of the electronic device corresponding to the track input working state
operating the input acquisition unit of the electronic device in a track input working mode, wherein the track input working mode comprises the input section accepting touch input, and
controlling the input section to not display the key section.

3. The method of claim 1, further comprising:
coating the key section of a cover plate of the electronic device with a first material; and
coating a section of the cover plate other than the key section with a second material, wherein the first material and the second material belong to a same color scheme, and a light transmittance of the first material is greater than that of the second material.

4. The method of claim 1, wherein determining the state of the electronic device comprises determining an angle between a first body and a second body of the electronic device.

5. The method of claim 4, wherein determining the angle between the first body and the second body comprises determining that the angle between the first body and the second body is greater than 0 degrees and less than 360 degrees, and the method further comprises operating the electronic device in a notebook working mode.

6. The method of claim 1, further comprising:
acquiring a switchover instruction; and
switching a working mode of the input acquisition unit from the key input working mode to a track input working mode based on the switchover instruction.

7. The method of claim 6, wherein acquiring the switchover instruction comprises:
acquiring a first parameter from a sensor; and
generating the switchover instruction based on the first parameter.

8. An electronic device comprising:
an input section;
an input acquisition unit; and
a processor coupled to the input acquisition unit, the processor being configured to:
determine a state of the electronic device,
determine whether the determined state corresponds to a key input working state, and
in response to the determined state corresponding to a key input working state
operate the input acquisition unit in a key input working mode, wherein the track input working mode comprises the input section accepting touch input, and
display a key section on the input section.

9. The electronic device of claim 8, wherein the processor is further configured to:
determine whether the determined state corresponds to a track input working state; and
in response to the determined state corresponding to a track input working state
operate the input acquisition unit in a track input working mode, and
control the input section to not display the key section.

10. The electronic device of claim 8, wherein a first material coats the key section of a cover plate of the electronic device, and a second material coats a section of the cover plate other than the key section, wherein the first material and the second material comprise a same color scheme, and a light transmittance of the first material is greater than a light transmittance of the second material.

11. The electronic device of claim 8, wherein the state of the electronic device comprises an angle between a first body and a second body of the electronic device.

12. The electronic device of claim 11, wherein in response to the angle between the first body and the second body being greater than 0 degrees and less than 360 degrees, the state of the electronic device comprises a notebook working mode.

13. The electronic device of claim 8, wherein the processor is further configured to:
acquire a switchover instruction; and
switch a working mode of the input acquisition unit from the key input working mode to a track input working mode based on the switchover instruction.

14. The electronic device of claim 12, wherein the processor is further configured to:
acquire a first parameter from a sensor; and
generate the switchover instruction based on the first parameter.

15. A program product comprising a non-transitory computer readable storage medium that stores code executable by a processor, the executable code comprising code to perform:
determining a state of an electronic device;
determining whether the determined state of the electronic device corresponds to a key input working state; and
in response to the determined state of the electronic device corresponding to a key input working state
operating an input acquisition unit of the electronic device in a key input working mode,
displaying a key section on an input section of the electronic device.

16. The program product of claim 15, wherein the executable code further comprises code to perform:
determining whether the determined state of the electronic device corresponds to a track input working state; and
in response to the determined state of the electronic device corresponding to the track input working state
operating the input acquisition unit of the electronic device in a track input working mode, wherein the track input working mode comprises the input section accepting touch input, and
controlling the input section to not display the key section.

17. The program product of claim 15, wherein a first material coats a key section of a cover plate of the electronic device, and a second material coats a section of the cover plate other than the key section, wherein the first material and the second material comprise a same color scheme, and a light transmittance of the first material is greater than a light transmittance of the second material.

18. The program product of claim 15, wherein the code to perform determining the state of the electronic device comprises code to perform determining an angle between a first body and a second body of the electronic device.

19. The program product of claim 18, wherein the code to perform determining the angle between the first body and the second body comprises code to perform determining that the angle between the first body and the second body is greater than 0 degrees and less than 360 degrees, and operating the electronic device in a notebook working mode.

20. The program product of claim 15, further comprising code to perform:
acquiring a switchover instruction; and
switching a working mode of the input acquisition unit from the key input working mode to a track input working mode based on the switchover instruction.
